(19) United States
(12) Patent Application Publication
(10) Pub. No.: US 2008/0077454 A1
(43) Pub. Date: Mar. 27, 2008

(54) Verified transaction evaluation

(75) Inventors: Ann Elizabeth Shepherd, San Francisco, CA (US); Thomas H. Layton, San Francisco, CA (US); Michael William Xenakis, Walnut Creek, CA (US); Charles Norman McCullough, Oakland, CA (US); Jocelyn Collins Morneau, San Francisco, CA (US); Scott McCarthy, San Francisco, CA (US)

Correspondence Address: VAN PELT, YI & JAMES LLP, 10050 N. FOOTHILL BLVD #200, CUPERTINO, CA, 95014, US

(73) Assignee: OpenTable, Inc.

(21) Appl. No.: 11/517,943

(22) Filed: Sep. 8, 2006

(51) Int. Cl. G06Q 10/00

(52) U.S. Cl. 705/5

(57) ABSTRACT

Verifying a transaction evaluation is disclosed. A transaction request is received from a user. A verification of the user's utilization of a good or service is received. The verification of use is received from a provider of the requested transaction. The user is qualified to provide an evaluation based at least in part on the verification.

### BACKGROUND OF THE INVENTION

Evaluations of goods or services can provide useful information to consumers and/or producers or providers. For ease, information can be gathered using electronic surveys or by accepting an evaluator's review at a web site. However, in many cases, the information gathered in this manner from an evaluator has unknown characteristics or qualifications—for example, it is not known if the evaluator has purchased or used the good or service for which the evaluator has provided an evaluation. It would be beneficial to be able to qualify a user when accepting a user's evaluation of a good or service.

### BRIEF DESCRIPTION OF THE DRAWINGS

Various embodiments of the invention are disclosed in the following detailed description and the accompanying drawings.

FIG. 1 is a block diagram illustrating an embodiment of system for verifying a transaction evaluation.

FIG. 2 is a flow diagram illustrating an embodiment of a process for verifying a transaction evaluation.

FIG. 3 is a flow diagram illustrating an embodiment of a process for verifying a transaction evaluation.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Verifying a transaction evaluation is disclosed. A transaction request is received from a user. A verification is received of the user's utilization of a good or service associated with the requested transaction. The verification is received from a service or goods provider of the requested transaction. The user is qualified to provide an evaluation based at least in part on the verification.

In some embodiments, the transaction is a restaurant reservation. For example, a user is verified by a restaurant to have used the reservation. The restaurant reservation may include a reservation restaurant name, a reservation date, a reservation party size, and/or a reservation time. In some embodiments, a diner's or user's name, phone number, and/or email address associated with the reservation is included. The verification of the user's utilization of fulfilling the restaurant reservation may be a confirmation that the user arrived at or was seated at the restaurant associated with the restaurant reservation, a confirmation that the user ordered at the restaurant associated with the restaurant reservation, or a confirmation that the user paid at the restaurant associated with the restaurant reservation. In some embodiments, a verification of the user's utilization is received from a software module that receives input from an employee of the restaurant. The software module that receives input from an employee of the restaurant may also receive information including reservation information, seating information, server information, chef information, order information, time and date information, cancellation information, arrival information, or payment information. In some embodiments, the software module comprises an electronic reservation book, a table management software package, and a customer relationship management software package.

In some embodiments, the user provides an evaluation by replying to an email, entering information at a web site, responding to a text message, responding to a voice message, providing information by phone, responding to a letter or questionnaire, being interviewed in-person, or any other appropriate manner of providing evaluation information. For example, a user is only allowed to provide an evaluation once for a verified user experience with a good or service, and the evaluation must be timely submitted (e.g., within a day, week or any other appropriate time window).

In various embodiments, a report or rating list (e.g., a top ten list: top romantic restaurant, top outdoor dining, top brunch, etc.) is produced based at least in part on one or more user-provided evaluations. The report may include information regarding purchases or average amount of purchases spent by one or more users, server performance as rated by one or more users, food quality as rated by one or more users, noise levels as rated by one or more users, ambiance as rated by one or more users, service quality as rated by one or more users, overall quality as rated by one or more users, or any other appropriate information for a report.

In some embodiments, a rating list based at least in part on the user provided evaluation comprises one or more of the following: a “Top <n>” (where <n> is an integer), “Best of”, or “Top <characteristic> list” (where <characteristic> comprises a characteristic such as bar, Sunday brunch, family style, Italian, Indian, view, late night, greasy burger, etc.

In various embodiments, the transaction is a reservation for a hotel reservation, an airplane reservation, a rental car reservation, an entertainment performance reservation, a sporting event reservation, a theater performance reservation, a dance performance reservation, a musical performance reservation, a museum reservation, a tour reservation, a movie rental, a movie theater reservation, a medical appointment, a vehicle repair appointment, an appliance repair appointment, a peripheral repair appointment, or a travel reservation. The reservation may include a reservation name, a reservation date, a reservation party size, and a reservation time. In some embodiments, a verification of a user's utilization of the good or service comprises of a confirmation from a service or goods provider employee that the user used the good or service associated with the reservation. The verification of the user's utilization of the good or service is received in some embodiments from a software module that receives input from an employee of the service or goods provider. Some software modules that receive input from an employee of the service or goods provider also receive reservation information, seating information, time and date information, and/or payment information.

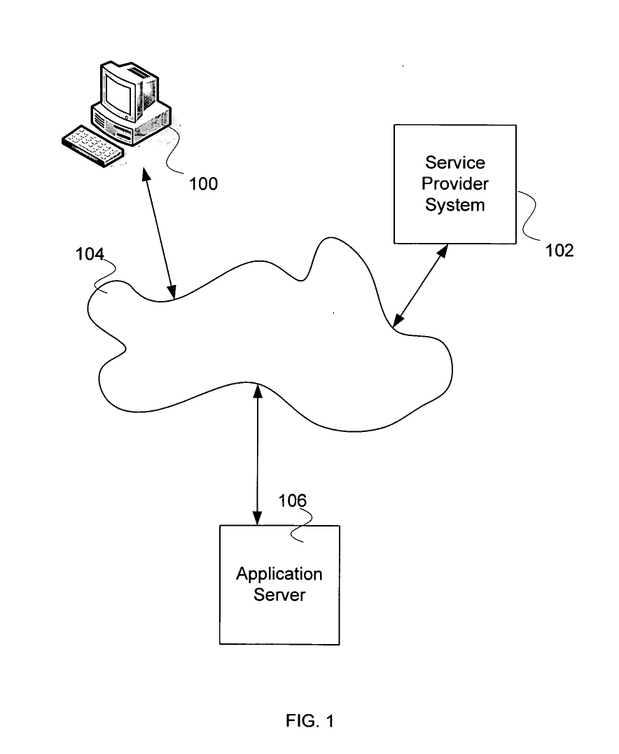

FIG. 1 is a block diagram illustrating an embodiment of system for verifying a transaction evaluation. In the example shown, a plurality of users using computer systems or some other device, represented by computer system 100 in FIG. 1, is connected with network 104 and can communicate with other systems or devices that are connected with network 104. Application server 106 is also connected with network 104. In some embodiments, a user (e.g., a user represented by computer system 100) communicates with application server 106 to request a transaction (e.g., a restaurant reservation). Service provider system 102 is also connected with network 104. In some embodiments, service provider system 102 comprises a system for a provider of goods and/or services. In some embodiments, application server 106 communicates with service provider system 102 (e.g., a restaurant reservation system) to enable the completion of the requested transaction (e.g., make the reservation) for the user. In some embodiments, application server 106 receives information regarding available inventory of goods or services (e.g., available reservations, tickets, etc.) and provides the information to the user enabling the user to reserve or purchase some of the goods or services. Once the user's desired transaction information is received, application server 106 indicates that to service provider system 102 that the inventory has been reserved or purchased. In some embodiments, network 104 comprises one or more of the following: a wireless network, a wired network, a local area network, a wider area network, the Internet, or any other appropriate communication network.

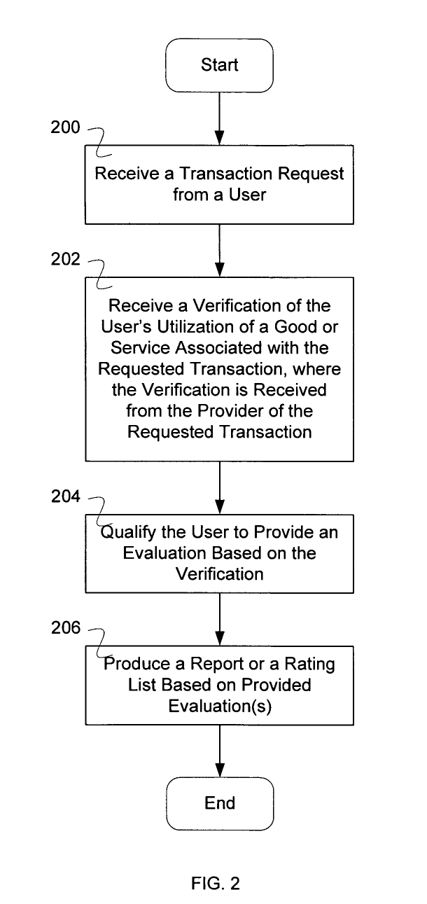

FIG. 2 is a flow diagram illustrating an embodiment of a process for verifying a transaction evaluation. In some embodiments, the process of FIG. 2 is executed on an application server such as application server 106 of FIG. 1. In the example shown, in 200 a transaction request is received from a user. In various embodiments, the transaction request comprises a request to reserve or purchase goods or services, such as a reservation at a restaurant, at a theater, at a hotel, for an airplane flight, for a train ticket, for a tour, for a cruise, for a bus, for a performance, for a movie, a medical appointment, a vehicle repair appointment, an appliance repair appointment, a peripheral repair appointment, or for any other appropriate item using reservations. In 202, a verification is received of the user's utilization of a good or service associated with the requested transaction, where the verification is received from the provider of the requested transaction. In some embodiments, the service or goods provider provides a service requiring a reservation, and when the user utilizes the service provider's service, it can be verified that the user utilized the service—for example, a restaurant can verify that a user honored the reservation, an airline company can verify that a user boarded a plane, etc.

In 204, the user can be qualified to provide an evaluation based at least in part on the verification. In some embodiments, a user is qualified if the user is verified appropriately as having used the service provider' service or the provider's good, and the user is allowed to provide feedback or an evaluation of the goods or services associated with the transaction and provided by the provider. In various embodiments, the qualified user is asked to respond to a targeted survey which may be via email, on a web page, via text messaging, via phone, or any other appropriate manner of gathering feedback or evaluation information from a qualified user. In some embodiments, the survey is performed using an encrypted web link that expires after one use or after a period of time to guarantee that the user only provides one set of feedback information and that the information is not inaccurate due to a long period having elapsed since the good or service was used by the user.

In 206, a report or a rating list is produced based on provided evaluation(s). In some embodiments, one or more reports or rating lists are provided to other users based at least in part on the user's evaluation—for example, ratings of a service or good provider, comparisons of providers, top providers in one or more categories. In various embodiments, a report is produced for other providers indicating ratings of the provider's performance, the provider's service, the provider's good, etc. For example, a user is informed through a report of restaurants rated highly by others, by a group of friends, by people who dined at similar restaurants, by people who gave similar ratings to a set of restaurants, by frequent diners at a particular restaurant, by association or grouping in a geographical location; a restaurant is informed through a report of ratings received on a certain day and shift, when certain servers or chefs were working, a user is informed through a rating list of the top Italian food restaurants in an area of a city, etc.

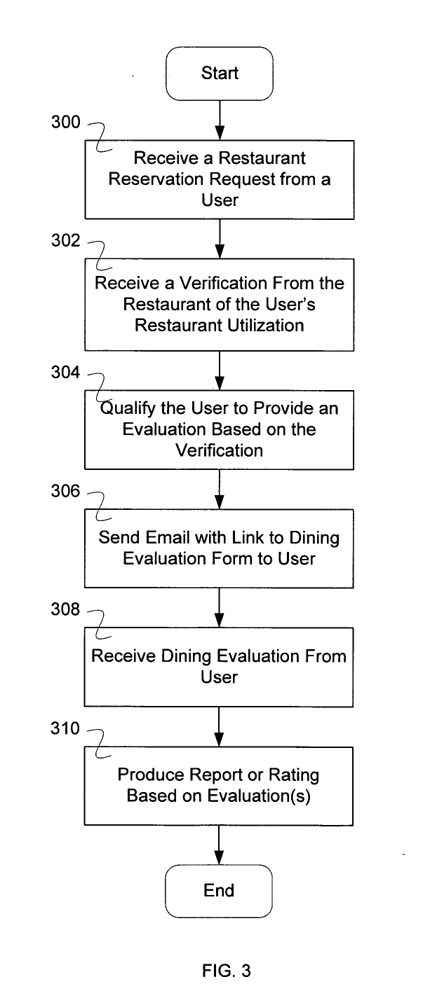

FIG. 3 is a flow diagram illustrating an embodiment of a process for verifying a transaction evaluation. In some embodiments, the process of FIG. 3 is executed on an application server such as application server 106 of FIG. 1. In the example shown, in 300 a restaurant reservation request is received from a user. In some embodiments, the restaurant reservation request is made with the knowledge of availability of reservations at one or more restaurants. In some cases suggestions are made on the basis of availability (e.g., times/dates available, seating party size availability, etc.), type of cuisine (e.g., Italian, Chinese, Thai, Californian, Mediterranean, etc.), location (e.g., distance away from home, neighborhood the restaurant is in, city area or region, etc.), price range for the restaurant, view, outdoor seating capability, kid friendliness, brunch availability, or any other appropriate criteria.

In 302, a verification is received from the restaurant that the user utilized the restaurant reservation. For example, an employee verifies that the diner whose name is associated with the reservation request arrives to be seated at the restaurant, is seated, orders, is served, orders dessert, requests check, or pays for meal. The employee can verify by entering the status (e.g., arrived, partially arrived, seated, ordered, served, dessert, check, paid, etc.) into an electronic reservation system that is used by the restaurant. In some embodiments, other status is entered—for example, confirmed, late, cancelled, called to cancel, no show, etc. In various embodiments, additional information is entered into the electronic reservation system for verification or information gathering purposes including but not limited to seating location, seating time, server, orders for the party, menu items, time the appetizer or entree was served, time the meal was completed, dessert ordered, check requested, table bussed, payment method (e.g., credit card type, name on card, etc.), tip -amount, chef(s) that prepared the order, bussing personnel serving the table, host(ess) name that seated the party, or any other appropriate information.

In 304, the user is qualified to provide an evaluation based on the verification. The user, once verified, is placed on a list to receive a solicitation to provide evaluation information. This ensures that the evaluation is performed by a verified user or customer of the restaurant.

In 306, an email is sent to the user with a link to a dining evaluation form. In some embodiments, the letter comprises an acknowledgement that the user made a recent reservation and was verified to have used the reservation. The letter asks for feedback from the user by sending an encrypted link. The encrypted link enables a user to navigate to a web-based form. The form requests feedback using radio buttons to select levels of quality (e.g., 5 stars down to one star, outstanding, very good, good, fair, poor, etc.) for food quality, ambiance, service, overall, noise level, or any other appropriate item that feedback is desired. In various embodiments, feedback regarding the restaurants fit to subjective categories is also requested—for example, categories such as fit for foodies, great for outdoor dining, neighborhood gem, special occasions, good for groups, hot spot, notable wine list, vibrant bar scene, great for brunch, kid-friendly, romantic, great for lunch, late-night find, scenic view, or any other appropriate category. Comments are solicited using a text input box. In various embodiments, feedback is requested using other survey techniques including rating based on numbers, yes or no questions, selecting adjectives, phone interviews, text messaging surveys, or any other appropriate ways for gathering feedback information. In some embodiments, feedback is not requested from those who make reservations or appointments on behalf of others, such as administrative assistants or concierges.

In 308, the dining evaluation form is received from the user. In some embodiments, the web-based form information is entered into a data analysis system and stored in a feedback database. In some embodiments, the data analysis system and feedback database are executed on an application server system such as application server 106 of FIG. 1. In some embodiments, the web-based form information is entered into a data analysis system used by restaurants to view reservation data and detailed trend analysis as well as aggregated/anonymous restaurant peer data for comparison.

In 310, a report or a rating list is produced based at least in part on the evaluation(s). In some embodiments, evaluations are aggregated and analyzed. In some embodiments, evaluations are reported individually. Reports can provide information to a user—for example, restaurants visited, number of times they have eaten out, types of food preferred, etc. Reports can provide information to a restaurant, a group of restaurants, a class of restaurants—for example, ratings with respect to peers on food, service, noise, overall, ambiance, etc. Reports can provide information to a particular restaurant with regard to a service at particular times, dates, shifts, for a given server, for a given chef, for a given table location, for a given host(ess), for a given bus person, for a given wine steward, etc. Ratings lists can provide most popular restaurant lists; highest ratings for food, noise, service, ambiance, etc.; most romantic, best outdoor, best view, best in neighborhood, most kid-friendly, best brunch, etc. In various embodiments, reviews are aggregated using all customers, a group of friends, a group of customers with similar ratings for a set of restaurants, a group of customers living in similar geographies or locations with similar characteristics, or any other appropriate way of aggregating the evaluation information. In some embodiments, a characteristic is rated by users and reported such as great for groups, romantic, great wine list, etc. that a user might apply to the business and/or their experience. For example, users might also be able to share information from the evaluation with other users.

In some embodiments, merging of data between the completed evaluation form and a specific reservation might produce reports for a restaurants' use, such as the ability for restaurants to measure themselves against peer restaurants they select in a manner where peer restaurant's identity is protected. Additionally, restaurants can produce reports, viewed based on permissions set by the restaurant, that feature data trending for specific days, shifts, servers, or average spend by a customer in terms of quality, ratings, and characteristics applied by users.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of verifying a transaction evaluation comprising:
receiving a transaction request from a user;
receiving a verification of the user's utilization of a good or service, wherein the verification of use is received from a provider of the requested transaction;
qualifying the user to provide an evaluation based at least in part on the verification.

2. A method as in claim 1, wherein the transaction comprises a restaurant reservation at a restaurant.

3. A method as in claim 2, wherein the restaurant reservation includes one or more of the following: a reservation restaurant name, restaurant address, restaurant phone number, cuisine type, price, neighborhood, hours of operation, a reservation date, a reservation party size, a reservation time, a user name, a user email, and a user phone number.

4. A method as in claim 2, wherein the verification of the user's utilization comprises one or more of the following: a confirmation that the user arrived at the restaurant, a confirmation that the user was seated at the restaurant associated with the restaurant reservation, a confirmation that the user ordered at the restaurant associated with the restaurant reservation, or a confirmation that the user paid at the restaurant associated with the restaurant reservation.

5. A method as in claim 2, wherein the verification of the user's utilization is received from a software module that receives input from an employee of the restaurant.

6. A method as in claim 5, wherein the software module that receives input from an employee of the restaurant also receives information including one or more of the following: reservation information, seating information, server information, chef information, order information, time and date information, cancellation information, arrival information, or payment information.

7. A method as in claim 1, wherein the transaction is a reservation for at least one of the following: a hotel reservation, an airplane reservation, a rental car reservation, an entertainment performance reservation, a sporting event reservation, a theater performance reservation, a dance performance reservation, a musical performance reservation, a museum reservation, a tour reservation, a movie rental, a movie theater reservation, a medical appointment, a vehicle repair appointment, an appliance repair appointment, a peripheral repair appointment, or a travel reservation.

8. A method as in claim 7, wherein the reservation includes one or more of the following: a reservation name, a reservation date, a reservation party size, a reservation time, a reservation contact information, a reservation contact email address, or a reservation contact phone number.

9. A method as in claim 7, wherein the verification of the user's utilization comprises a confirmation from a provider employee that the user used the good or service associated with the reservation.

10. A method as in claim 7, wherein the verification of the user's utilization is received from a software module that receives input from an employee of the provider.

11. A method as in claim 10, wherein the software module that receives input from an employee of the goods or service provider also receives information including one or more of the following: reservation information, seating information, time and date information, or payment information.

12. A method as in claim 1, wherein the user provides an evaluation by one or more of the following: replying to an email, entering information at a web site, providing information via phone, responding to a text message, responding to a voice message, or responding to a letter or questionnaire, or in-person interview.

13. A method as in claim 1, wherein the user is only allowed to provide an evaluation once for a verified user utilization of a good or service.

14. A method as in claim 1, further comprising producing a report based at least in part on the user provided evaluation.

15. A method as in claim 1, further comprising producing a report based at least in part on the user provided evaluation, wherein the report includes information regarding one or more of the following: dollars spent by one or more users, server performance as rated by one or more users, chef quality as rated by one or more users, noise levels as rated by one or more users, ambiance as rated by one or more users, service quality as rated by one or more users, location as rated by one or more users, view as rated by one or more users, or cleanliness as rated by one or more users.

16. A method as in claim 1, further comprising producing a rating list based at least in part on the user provided evaluation.

17. A method as in claim 1, further comprising producing a rating list based at least in part on the user provided evaluation, wherein the rating list is one or a combination of a “Top <n>” or “Best of” or “Top <characteristic> list”.

18. A computer program product for verifying a transaction evaluation, the computer program product being embodied in a computer readable medium and comprising computer instructions for:
receiving a transaction request from a user;
receiving a verification of the user's utilization of a good or service associated with the requested transaction, wherein the verification is received from a provider of the requested transaction;
qualifying the user to provide an evaluation based at least in part on the verification.

19. A system for verifying a transaction evaluation comprising:
a processor; and
a memory coupled with the processor, wherein the memory is configured to provide the processor with instructions which when executed cause the processor to:
receive a transaction request from a user;
receive a verification of the user's utilization of a good or service associated with the requested transaction, wherein the verification is received from a provider of the requested transaction;
qualify the user to provide an evaluation based at least in part on the verification.
